(19) United States
(12) Patent Application Publication
(10) Pub. No.: US 2026/0186441 A1
(43) Pub. Date: Jul. 2, 2026

(54) IMAGE FORMING APPARATUS WITH MULTIPLE TONER CONTAINERS FOR EACH SAME COLOR FITTED THEREIN, AND NON-TRANSITORY COMPUTER-READABLE RECORDING MEDIUM WITH OPERATION CONTROL PROGRAM STORED THEREIN

(71) Applicant: KYOCERA Document Solutions Inc., Osaka (JP)

(72) Inventor: Yusuke KATO, Osaka (JP)

(73) Assignee: KYOCERA Document Solutions Inc., Osaka (JP)

(21) Appl. No.: 19/394,972

(22) Filed: Nov. 20, 2025

(30) Foreign Application Priority Data
Nov. 28, 2024 (JP) 2024-207354

(51) Int. Cl. G03G 21/16; G03G 15/00; G03G 15/08

(52) U.S. Cl. CPC G03G 21/1652; G03G 15/0856; G03G 15/0863; G03G 15/0865; G03G 15/556; G03G 21/1633; G03G 2221/163; G03G 2221/1654; G03G 2221/169; G03G 2221/1823

(57) ABSTRACT

An image forming apparatus includes an image forming device and an operation controller. The image forming device includes a plurality of toner containers for each same color fitted therein and does printing. The image forming device includes, for the plurality of toner containers, respective removal restricting devices that restrict removal of the respective associated toner containers. The operation controller manages an in-use container which is, among the plurality of toner containers, the toner container used for execution of the printing, allows the removal restricting device for the in-use container to restrict the removal of the in-use container during the execution of the printing, and lifts, during the execution of the printing, restriction imposed by the other removal restricting devices on the removal of the toner containers other than the in-use container.

### INCORPORATION BY REFERENCE

This application claims priority to Japanese Patent Application No. 2024-207354 filed on Nov. 28, 2024, the entire contents of which are incorporated by reference herein.

### BACKGROUND

The present disclosure relates to image forming apparatuses with multiple toner containers for each same color fitted therein, and non-transitory computer-readable recording media with operation control programs stored therein.

As an example of an image forming apparatus, there is known an image forming apparatus in which toner containers can be replaced.

### SUMMARY

A technique improved over the aforementioned technique is proposed as one aspect of the present disclosure.

An image forming apparatus according to an aspect of the present disclosure includes an image forming device and a control device. The image forming device includes a plurality of toner containers for each same color fitted therein and does printing. The image forming device includes, for the plurality of toner containers, respective removal restricting devices that restrict removal of the respective associated toner containers. The control device includes a processor and functions as an operation controller through the processor executing a control program. The operation controller manages an in-use container which is, among the plurality of toner containers, the toner container used for execution of the printing, allows the removal restricting device for the in-use container to restrict the removal of the in-use container during the execution of the printing, and lifts, during the execution of the printing, restriction imposed by the other removal restricting devices on the removal of the toner containers other than the in-use container.

A non-transitory computer-readable recording medium according to another aspect of the present disclosure stores an operation control program. The operation control program allows a computer included in an image forming apparatus, the image forming apparatus including: a plurality of toner containers for each same color fitted therein; and, for the plurality of toner containers, respective removal restricting devices that restrict removal of the respective associated toner containers, to operate to manage an in-use container which is, among the plurality of toner containers, the toner container used for execution of printing, allow the removal restricting device for the in-use container to restrict the removal of the in-use container during the execution of printing, and lift, during the execution of printing, restriction imposed by the other removal restricting devices on the removal of the toner containers other than the in-use container.

### BRIEF DESCRIPTION OF THE DRAWINGS

FIG. 1 is a block diagram of an example of an image forming apparatus according to an embodiment of the present disclosure.

FIG. 2 is a schematic cross-sectional side view of the image forming apparatus shown in FIG. 1.

FIG. 3 is a block diagram of a printer shown in FIG. 1.

FIG. 4 is a schematic perspective view of a portion of the image forming apparatus shown in FIG. 1 when a toner cover is closed.

FIG. 5 is a schematic perspective view of the portion of the image forming apparatus shown in FIG. 1 when the toner cover is open and all container covers are closed.

FIG. 6 is a schematic perspective view of the portion of the image forming apparatus shown in FIG. 1 when all the container covers are open.

FIG. 7 is a diagram showing an example of container empty warning subject information shown in FIG. 1.

FIG. 8 is a diagram showing an example of container empty error subject information shown in FIG. 1.

FIG. 9 is a diagram showing an example of in-use container information shown in FIG. 1.

FIG. 10 is a flowchart of an operation of the image forming apparatus shown in FIG. 1 for a container empty warning.

FIG. 11 is a flowchart of an operation of the image forming apparatus shown in FIG. 1 in controlling container locks.

FIG. 12 is a flowchart of an operation of the image forming apparatus shown in FIG. 1 for a container empty error.

FIG. 13 is a flowchart of an operation of the image forming apparatus shown in FIG. 1 in determining whether to prohibit or allow printing.

### DETAILED DESCRIPTION

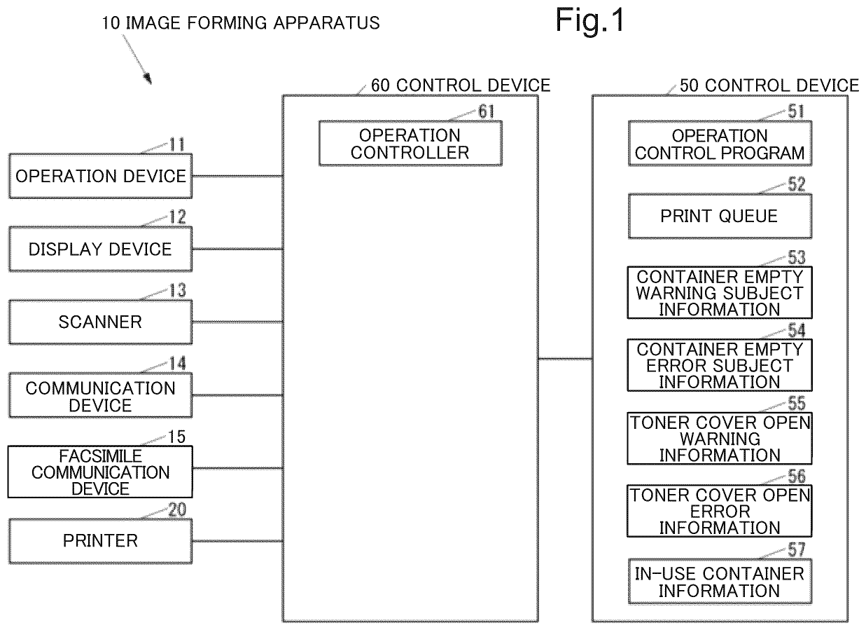

Hereinafter, a description will be given of an image forming apparatus and a non-transitory computer-readable recording medium with an operation control program stored therein, each according to one embodiment of the present disclosure, with reference to the drawings. First, a description will be given of the structure of the image forming apparatus according to the one embodiment of the present disclosure. FIG. 1 is a block diagram of an example of an image forming apparatus 10 according to this embodiment.

As shown in FIG. 1, the image forming apparatus 10 includes: an operation device 11 which is an operation device, such as buttons, through which various operations are to be input; a display device 12 (an example of a notification device) which is a display device, such as an LCD (liquid crystal display), that displays various information; a scanner 13 which is a reading device that reads an image from an original document; a communication device 14 which is a communication device that communicates with external devices via a network, such as a LAN (local area network) or the Internet, or directly by wire or wireless without any network; a facsimile communication device 15 which is a facsimile device that does facsimile communication via communication lines, such as public phone lines, with unshown external facsimile devices; a printer 20 (an example of an image forming device) which is a printing device formed of an electrophotographic image formation mechanism that prints an image on a recording medium, such as a sheet of paper; a storage device 50 which is a non-volatile storage device, such as a semiconductor memory or an HDD (hard disk drive), that stores various information; and a control device 60.

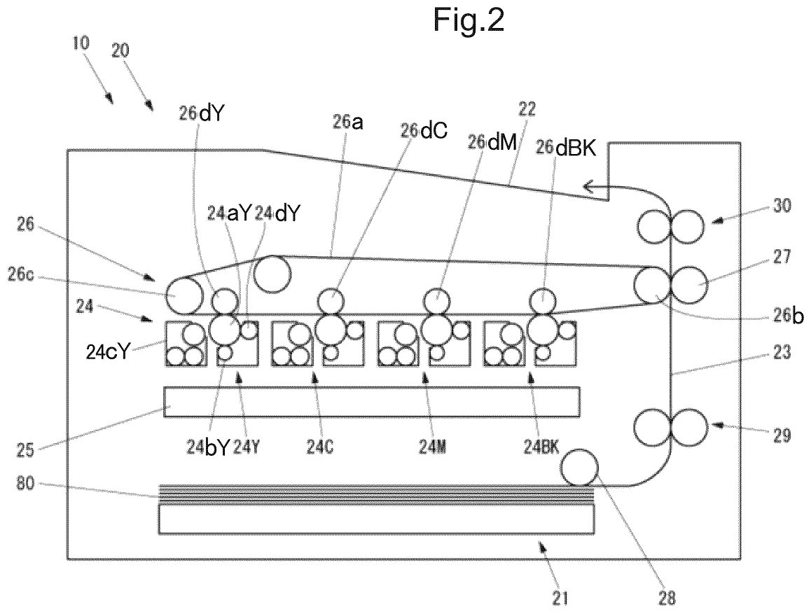

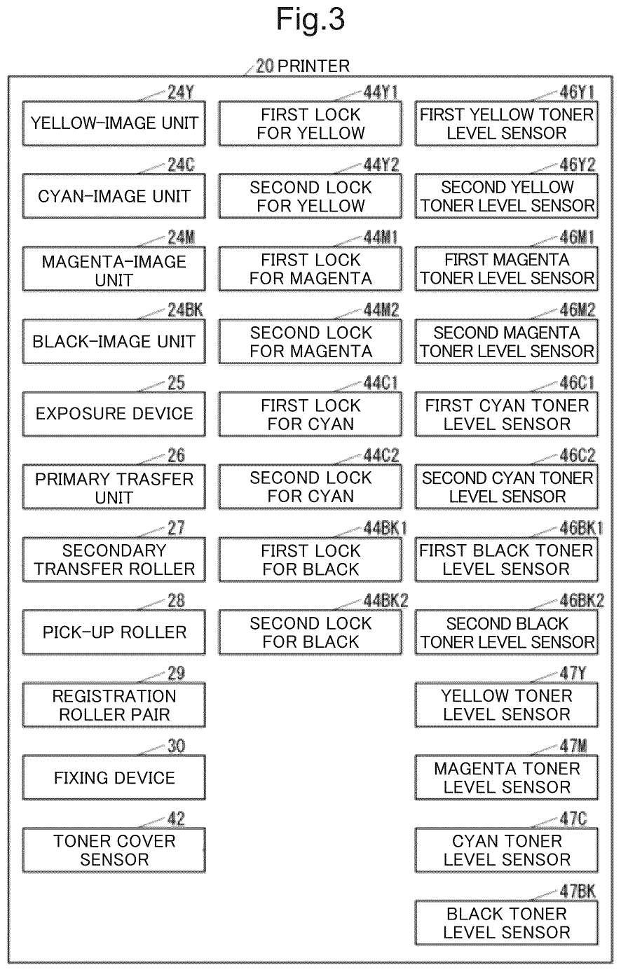

FIG. 2 is a schematic cross-sectional side view of the image forming apparatus 10. FIG. 3 is a block diagram of the printer 20.

As shown in FIGS. 2 and 3, the printer 20 includes: a feed device 21 that feeds recording media 80, such as sheets of paper; an ejection device 22 where the recording medium 80 with an image printed thereon is to be ejected; a conveyance path 23 for the recording medium 80 extending from the feed device 21 to the ejection device 22; a set of image formation units (hereinafter, referred to as an “image formation unit set”) 24 that form images of toner (hereinafter, referred to as “toner images”); an exposure device 25 that are common to all the image formation units and irradiates the respective peripheral surfaces of later-described photosensitive drums of the image formation unit set 24 with light based on image data to form respective electrostatic latent images on the peripheral surfaces of the photosensitive drums; primary transfer units 26 to which the respective toner images formed by the image formation unit set 24 are to be transferred; a secondary transfer roller 27 that transfers the toner images transferred to the primary transfer units 26 to a recording medium 80; a pick-up roller 28 that feeds out a recording medium 80 from the feed device 21; a registration roller pair 29 that does skew correction of the recording medium 80 fed out by the pick-up roller 28 and delivers the recording medium 80 toward the secondary transfer roller 27 with a predetermined timing; and a fixing device 30 that fixes the toner image formed on the recording medium 80.

The image formation unit set 24 includes a yellow-image unit 24Y serving as an image formation unit that forms a yellow toner image, a cyan-image unit 24C serving as an image formation unit that forms a cyan toner image, a magenta-image unit 24M serving as an image formation unit that forms a magenta toner image, a black-image unit 24BK serving as an image formation unit that forms a black toner image.

The yellow-image unit 24Y includes a photosensitive drum 24aY capable of being driven into rotation around a central axis thereof, a charging device 24bY that uniformly charges the peripheral surface of the photosensitive drum 24aY, a developing device 24cY that supplies toner to the peripheral surface of the photosensitive drum 24aY to develop an electrostatic latent image formed on the peripheral surface of the photosensitive drum 24aY, i.e., make it explicit, and a cleaning device 24dY that cleans the peripheral surface of the photosensitive drum 24aY after the toner image has been transferred to a later-described primary transfer belt.

The structures of the cyan-image unit 24C, the magenta-image unit 24M, and the black-image unit 24BK are the same as that of the yellow-image unit 24Y and, therefore, further explanation thereof will be accordingly omitted.

The primary transfer unit 26 includes: a primary transfer belt 26a to the surface of which respective toner images are to be transferred from the photosensitive drums of the image formation unit set 24; a drive roller 26b that allows the primary transfer belt 26a to travel therearound; a driven roller 26c that applies, together with the drive roller 26b, a tension to the primary transfer belt 26a; a yellow-image transfer roller 26dY as a primary transfer roller that transfers onto the primary transfer belt 26a the toner image on the photosensitive drum 24aY of the yellow-image unit 24Y; a cyan-image transfer roller 26dC as a primary transfer roller that transfers onto the primary transfer belt 26a the toner image on the photosensitive drum of the cyan-image unit 24C; a magenta-image transfer roller 26dM as a primary transfer roller that transfers onto the primary transfer belt 26a the toner image on the photosensitive drum of the magenta-image unit 24M; and a black-image transfer roller 26dBK as a primary transfer roller that transfers onto the primary transfer belt 26a the toner image on the photosensitive drum of the black-image unit 24BK.

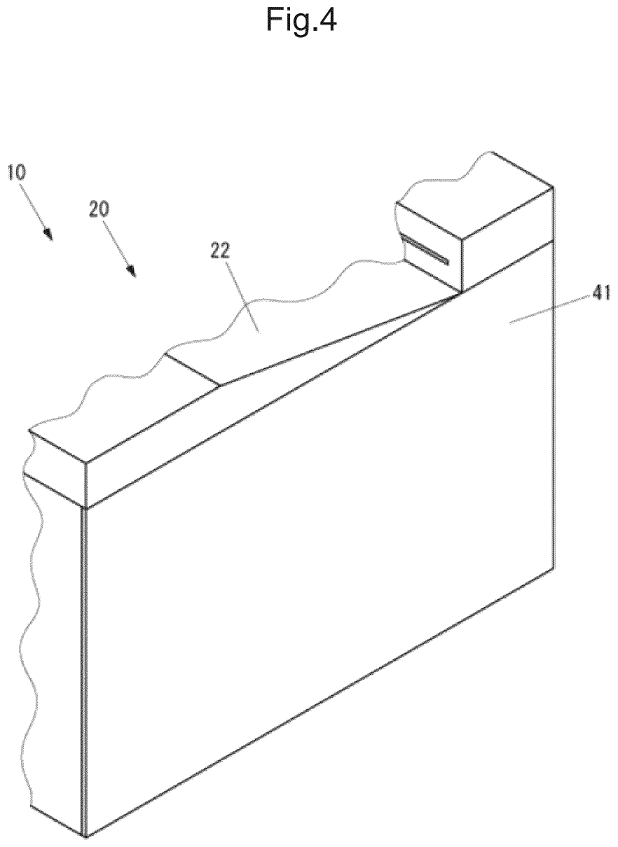

FIG. 4 is a schematic perspective view of a portion of the image forming apparatus 10 when a toner cover 41 is closed.

As shown in FIG. 4, the printer 20 includes a toner cover 41 that can be opened for replacement of later-described toner containers for use in supplying toner to the respective developing devices of the image formation units.

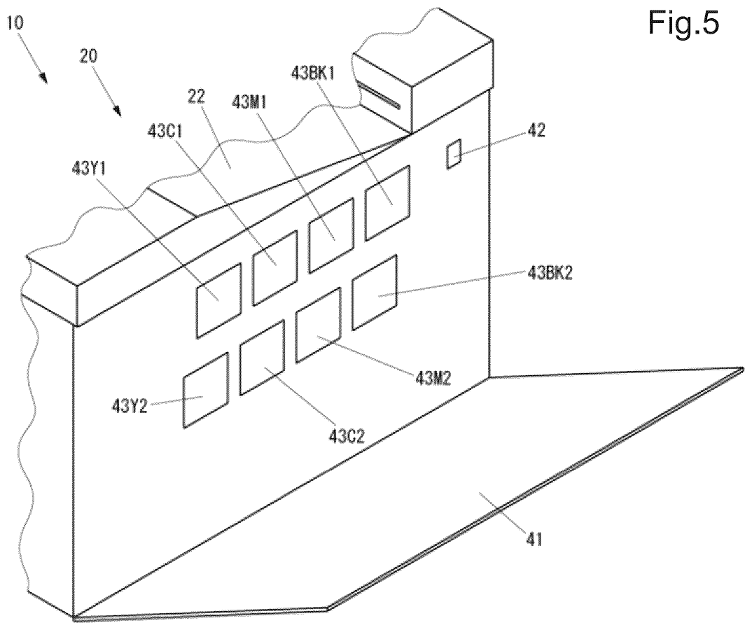

FIG. 5 is a schematic perspective view of the portion of the image forming apparatus 10 when the toner cover 41 is open and all container covers are closed.

As shown in FIGS. 3 and 5, the printer 20 includes a toner cover sensor 42, such as, for example, a photosensor, that detects whether the toner cover 41 is open or closed.

As shown in FIG. 5, the printer 20 includes, as container covers to be opened for replacement of toner containers, a first cover 43Y1 for yellow and a second cover 43Y2 for yellow each capable of being opened for replacement of yellow toner containers, a first cover 43C1 for cyan and a second cover 43C2 for cyan each capable of being opened for replacement of cyan toner containers, a first cover 43M1 for magenta and a second cover 43M2 for magenta each capable of being opened for replacement of magenta toner containers, and a first cover 43BK1 for black and a second cover 43BK2 for black each capable of being opened for replacement of black toner containers. The container covers and the toner cover 41 are designed to be opened and closed manually by the user. The container covers cannot be opened while the toner cover 41 is closed.

The image forming apparatus 10 is, as shown in FIG. 5, a dual container type image forming apparatus into which two toner containers can be fitted for each of yellow, cyan, magenta, and black toners.

As shown in FIG. 3, the printer 20 includes, as container locks that lock the respective associated container covers, a first lock 44Y1 for yellow that locks the first cover 43Y1 for yellow, a second lock 44Y2 for yellow that locks the second cover 43Y2 for yellow, a first lock 44C1 for cyan that locks the first cover 43C1 for cyan, a second lock 44C2 for cyan that locks the second cover 43C2 for cyan, a first lock 44M1 for magenta that locks the first cover 43M1 for magenta, a second lock 44M2 for magenta that locks the second cover 43M2 for magenta, a first lock 44BK1 for black that locks the first cover 43BK1 for black, and a second lock 44BK2 for black that locks the second cover 43BK2 for black.

The container locks lock the respective container covers to restrict removal of the respective toner containers from the image forming apparatus 10. Therefore, each combination of the container cover and the associated container lock is an example of the removal restricting device.

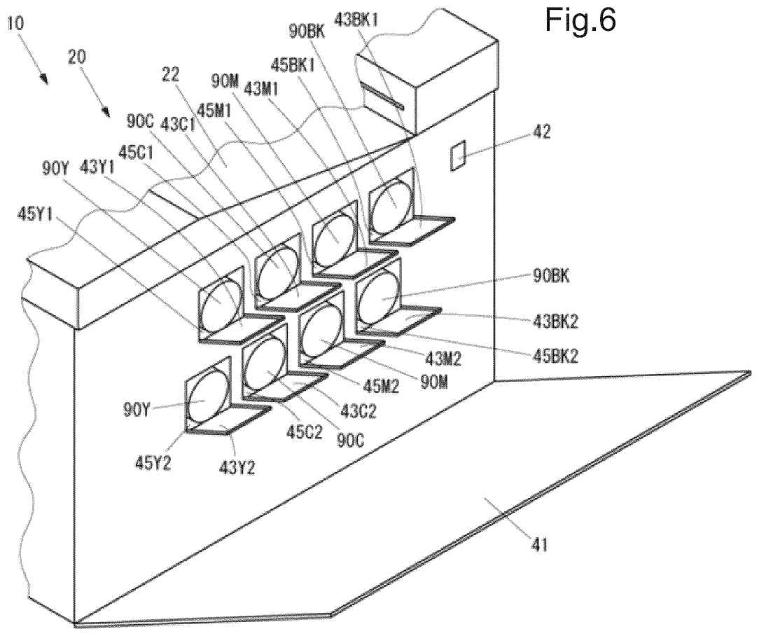

FIG. 6 is a schematic perspective view of the portion of the image forming apparatus 10 when all the container covers are open.

As shown in FIG. 6, the printer 20 includes, as container fitting sockets into which the respective toner containers are to be fitted, a first fitting socket 45Y1 for yellow which is exposed with the first cover 43Y1 for yellow open and into which a yellow toner container 90Y is to be fitted, a second fitting socket 45Y2 for yellow which is exposed with the second cover 43Y2 for yellow open and into which a yellow toner container 90Y is to be fitted, a first fitting socket 45C1 for cyan which is exposed with the first cover 43C1 for cyan open and into which a cyan toner container 90C is to be fitted, a second fitting socket 45C2 for cyan which is exposed with the second cover 43C2 for cyan open and into which a cyan toner container 90C is to be fitted, a first fitting socket 45M1 for magenta which is exposed with the first cover 43M1 for magenta open and into which a magenta toner container 90M is to be fitted, a second fitting socket 45M2 for magenta which is exposed with the second cover 43M2 for magenta open and into which a magenta toner container 90M is to be fitted, a first fitting socket 45BK1 for black which is exposed with the first cover 43BK1 for black open and into which a black toner container 90BK is to be fitted, and a second fitting socket 45BK2 for black which is exposed with the second cover 43BK2 for black open and into which a black toner container 90BK is to be fitted.

As shown in FIG. 3, the printer 20 includes, as container toner level sensors that detect the toner levels in the respective toner containers, a first yellow toner level sensor 46Y1 that detects the toner level in the toner container 90Y fitted in the first fitting socket 45Y1 for yellow, a second yellow toner level sensor 46Y2 that detects the toner level in the toner container 90Y fitted in the second fitting socket 45Y2 for yellow, a first cyan toner level sensor 46C1 that detects the toner level in the toner container 90C fitted in the first fitting socket 45C1 for cyan, a second cyan toner level sensor 46C2 that detects the toner level in the toner container 90C fitted in the second fitting socket 45C2 for cyan, a first magenta toner level sensor 46M1 that detects the toner level in the toner container 90M fitted in the first fitting socket 45M1 for magenta, a second magenta toner level sensor 46M2 that detects the toner level in the toner container 90M fitted in the second fitting socket 45M2 for magenta, a first black toner level sensor 46BK1 that detects the toner level in the toner container 90BK fitted in the first fitting socket 45BK1 for black, and a second black toner level sensor 46BK2 that detects the toner level in the toner container 90BK fitted in the second fitting socket 45BK2 for black. The container toner level sensor is formed of, for example, a permeability sensor or a photosensor.

The printer 20 includes: an unshown hopper that is supplied with toner from both the toner container 90Y fitted in the first fitting socket 45Y1 for yellow and the toner container 90Y fitted in the second fitting socket 45Y2 for yellow and supplies the toner to the developing device 24cY of the yellow-image unit 24Y; a yellow toner level sensor 47Y as a hopper toner level sensor that detects the toner level in the above hopper for yellow toner; an unshown hopper that is supplied with toner from both the toner container 90C fitted in the first fitting socket 45C1 for cyan and the toner container 90C fitted in the second fitting socket 45C2 for cyan and supplies the toner to the developing device of the cyan-image unit 24C; a cyan toner level sensor 47C as a hopper toner level sensor that detects the toner level in the above hopper for cyan toner; an unshown hopper that is supplied with toner from both the toner container 90M fitted in the first fitting socket 45M1 for magenta and the toner container 90M fitted in the second fitting socket 45M2 for magenta and supplies the toner to the developing device of the magenta-image unit 24M; a magenta toner level sensor 47M as a hopper toner level sensor that detects the toner level in the above hopper for magenta toner; an unshown hopper that is supplied with toner from both the toner container 90BK fitted in the first fitting socket 45BK1 for black and the toner container 90BK fitted in the second fitting socket 45BK2 for black and supplies the toner to the developing device of the black-image unit 24BK; and a black toner level sensor 47BK as a hopper toner level sensor that detects the toner level in the above hopper for black toner.

The storage device 50 shown in FIG. 1 stores an operation control program 51 for use in controlling operations of the image forming apparatus 10. The operation control program 51 may be installed in the storage device 50, for example, at the production stage of the image forming apparatus 10, installed therein from an external storage medium, such as a USB (universal serial bus) or additionally installed therein via the communication device 14 from a network.

The storage device 50 stores a print queue 52 in which print jobs are to be accumulated. The print queue 52 accumulates: print jobs being executed by the printer 20; and print jobs waiting to be executed by the printer 20. The print jobs accumulated in the print queue 52 are sequentially executed by the printer 20 under the control of an operation controller 61. The print queue may be stored, not in the storage device 50, but in a later-described RAM of the control device 60.

The storage device 50 further stores container empty warning subject information 53 showing any toner container subject to a container empty warning indicating a warning that the toner level in the toner container is not enough.

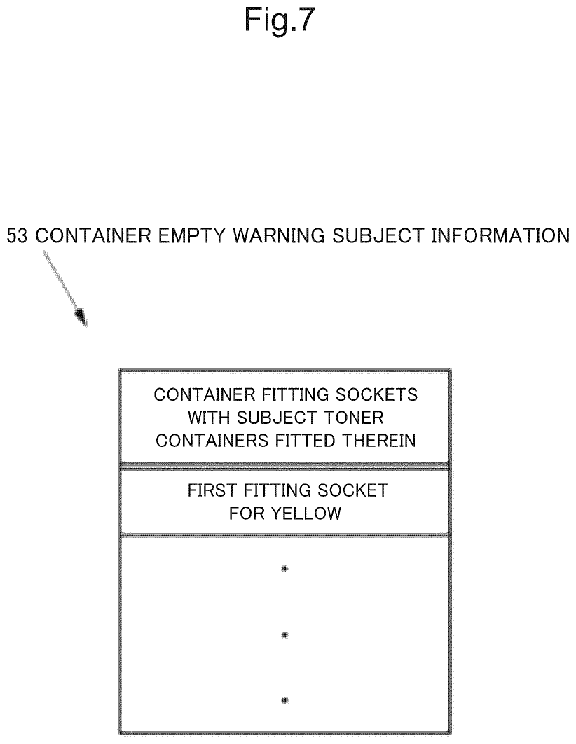

FIG. 7 is a diagram showing an example of the container empty warning subject information 53. As shown in FIG. 7, the container empty warning subject information 53 shows any container fitting socket in which a toner container subject to a container empty warning is fitted, and thus shows any toner container subject to the container empty warning. In FIG. 7, part of the container empty warning subject information 53 is omitted.

As shown in FIG. 1, the storage device 50 stores container empty error subject information 54 showing any toner color subject to a container empty error indicating an error of the associated toner containers not having enough toner level.

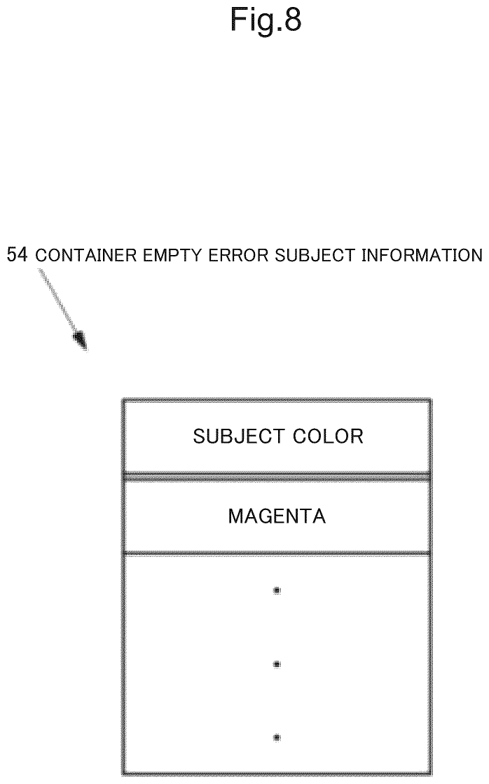

FIG. 8 is a diagram showing an example of the container empty error subject information 54. As shown in FIG. 8, the container empty error subject information 54 shows any toner color subject to a container empty error. In FIG. 8, part of the container empty error subject information 54 is omitted.

As shown in FIG. 1, the storage device 50 stores: toner cover open warning information 55 showing whether or not a toner cover open warning indicating a warning that the toner cover 41 is open is being issued; and toner cover open error information 56 showing whether or not a toner cover open error indicating an error of the toner cover 41 being open is occurring.

The storage device 50 stores in-use container information 57 showing, among respective pairs of yellow, cyan, magenta, and black toner containers, toner containers for use during execution of printing by the printer 20 (hereinafter, referred to as “in-use containers”).

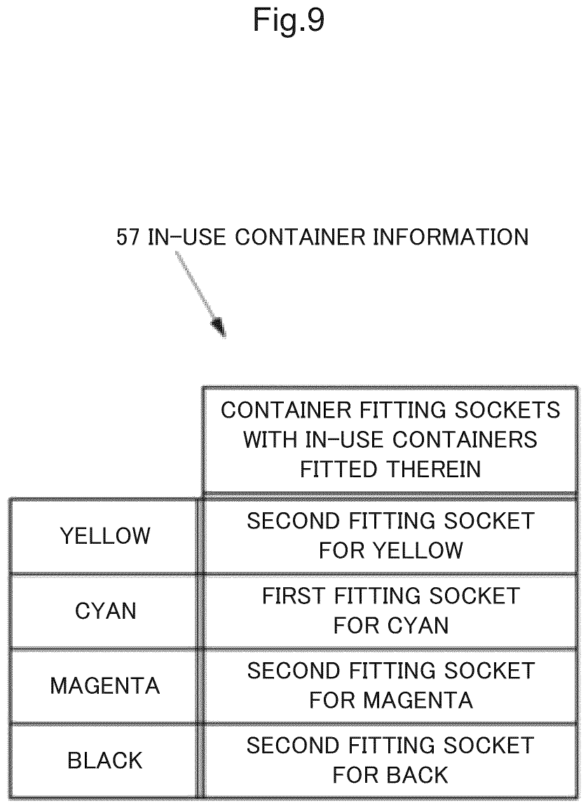

FIG. 9 is a diagram showing an example of the in-use container information 57. As shown in FIG. 9, the in-use container information 57 shows container fitting sockets in which in-use containers are fitted, and thus shows the in-use containers. The in-use container information 57 shows the in-use containers, one for each of the yellow, cyan, magenta, and black toners.

The control device 60 shown in FIG. 1 is made up of a processor, a RAM (random access memory), a ROM (read only memory), and so on. The processor is an example of the computer and is, for example, a CPU (central processing unit), an MPU (micro processing unit) or an ASIC (application specific integrated circuit). In this embodiment, a description will be given of the case where the processor is a CPU. When the CPU executes the operation control program 51 stored in the storage device 50, the control device 60 functions as an operation controller 61. The operation controller 61 governs the overall operation control of the image forming apparatus 10. The above ROM stores various data. The RAM is a memory for use as a working area for the CPU. The processor also executes programs stored in the ROM of the control device 60.

Next, a description will be given of operations of the image forming apparatus 10. First, a description will be given of an operation of the image forming apparatus 10 for a container empty warning.

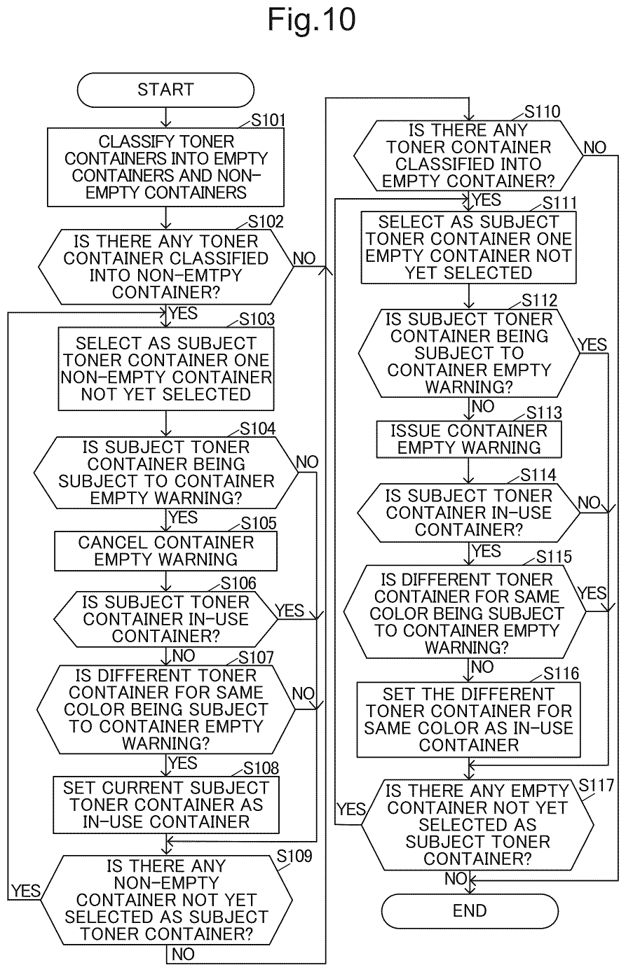

FIG. 10 is a flowchart of the operation of the image forming apparatus 10 for a container empty warning.

The operation controller 61 executes the operation shown in FIG. 10 with a specified timing, such as, for example, at regular intervals.

As shown in FIG. 10, based on detection results of the container toner level sensors, the operation controller 61 classifies the toner containers fitted in the image forming apparatus 10 into: toner containers having a toner level less than a specified amount (hereinafter, referred to as “empty containers”); and toner containers having a toner level not less than the specified amount (hereinafter, referred to as “non-empty containers”) (S101).

When the processing step S101 ends, the operation controller 61 determines whether or not there is any toner container classified into a non-empty container in S101 (S102).

When determining in S102 that there is any toner container classified into a non-empty container in S101, the operation controller 61 selects as a subject toner container, among the toner containers classified into non-empty containers in S101, one not yet selected as a subject in this processing shown in FIG. 10 (S103).

When the processing step S103 ends, the operation controller 61 determines, based on container empty warning subject information 53, whether or not the currently selected subject toner container is being subject to a container empty warning (S104).

When determining in S104 that the currently selected subject toner container is being subject to a container empty warning, the operation controller 61 cancels a container empty warning on the currently selected subject toner container (S105). Specifically, the operation controller 61 allows the display device 12 to terminate displaying a container empty warning on the currently selected subject toner container and deletes the currently selected subject toner container from the container empty warning subject information 53.

When the processing step S105 ends, the operation controller 61 determines, based on in-use container information 57, whether or not the currently selected subject toner container is an in-use container (S106).

When determining in S106 that the currently selected subject toner container is not an in-use container, the operation controller 61 determines, based on the container empty warning subject information 53, whether or not, among the toner containers fitted in the image forming apparatus 10, the toner container for supplying toner of the same color as the toner of the currently selected subject toner container is being subject to a container empty warning (S107).

When determining in S107 that the toner container for supplying toner of the same color as the toner of the currently selected subject toner container is being subject to a container empty warning, the operation controller 61 sets, in the in-use container information 57, the currently selected subject toner container as an in-use container (S108). Thus, the operation controller 61 controls the printer 20 to supply toner, not from the toner container for supplying toner of the same color as the toner of the currently selected subject toner container, but from the currently selected subject toner container.

When the operation controller 61 determines in S104 that the currently selected subject toner container is not being subject to a container empty warning, determines in S106 that the currently selected subject toner container is an in-use container, or determines in S107 that the toner container for supplying toner of the same color as the toner of the currently selected subject toner container is not being subject to a container empty warning or the processing step S108 ends, the operation controller 61 determines whether or not there is, among the toner containers classified into non-empty containers in S101, any toner container not yet selected as a subject in this processing shown in FIG. 10 (S109).

When determining in S109 that there is, among the toner containers classified into non-empty containers in S101, any toner container not yet selected as a subject in this processing shown in FIG. 10, the operation controller 61 executes the processing step S103.

When determining in S102 that there is no toner container classified into a non-empty container in S101 or determining in S109 that there is, among the toner containers classified into non-empty containers in S101, no toner container not yet selected as a subject in this processing shown in FIG. 10, the operation controller 61 determines whether or not there is any toner container classified into an empty container in S101 (S110).

When determining in S110 that there is any toner container classified into an empty container in S101, the operation controller 61 selects as a subject toner container, among the toner containers classified into empty containers in S101, one not yet selected as a subject in this processing shown in FIG. 10 (S111).

When the processing step S111 ends, the operation controller 61 determines, based on the container empty warning subject information 53, whether or not the currently selected subject toner container is being subject to a container empty warning (S112).

When determining in S112 that the currently selected subject toner container is not being subject to a container empty warning, the operation controller 61 issues a container empty warning on the currently selected subject toner container (S113). Specifically, the operation controller 61 allows the display device 12 to start displaying a container empty warning on the currently selected subject toner container and adds the currently selected subject toner container into the container empty warning subject information 53.

When the processing step S113 ends, the operation controller 61 determines, based on the in-use container information 57, whether or not the currently selected subject toner container is an in-use container (S114).

When determining in S114 that the currently selected subject toner container is an in-use container, the operation controller 61 determines, based on the container empty warning subject information 53, whether or not, among the toner containers fitted in the image forming apparatus 10, the toner container for supplying toner of the same color as the toner of the currently selected subject toner container is being subject to a container empty warning (S115).

When determining in S115 that the toner container for supplying toner of the same color as the toner of the currently selected subject toner container is not being subject to a container empty warning, the operation controller 61 sets, in the in-use container information 57, the toner container for supplying toner of the same color as the toner of the currently selected subject toner container as an in-use container (S116). Thus, the operation controller 61 controls the printer 20 to supply toner, not from the currently selected subject toner container, but from the toner container for supplying toner of the same color as the toner of the currently selected subject toner container.

When the operation controller 61 determines in S112 that the currently selected subject toner container is being subject to a container empty warning, determines in S114 that the currently selected subject toner container is not an in-use container, or determines in S115 that the toner container for supplying toner of the same color as the toner of the currently selected subject toner container is being subject to a container empty warning or the processing step S116 ends, the operation controller 61 determines whether or not there is, among the toner containers classified into empty containers in S101, any toner container not yet selected as a subject in this processing shown in FIG. 10 (S117).

When determining in S117 that there is, among the toner containers classified into empty containers in S101, any toner container not yet selected as a subject in this processing shown in FIG. 10, the operation controller 61 executes the processing step S111.

When determining in S110 that there is no toner container classified into an empty container in S101 or determining in S117 that there is, among the toner containers classified into empty containers in S101, no toner container not yet selected as a subject in this processing shown in FIG. 10, the operation controller 61 ends the operation shown in FIG. 10.

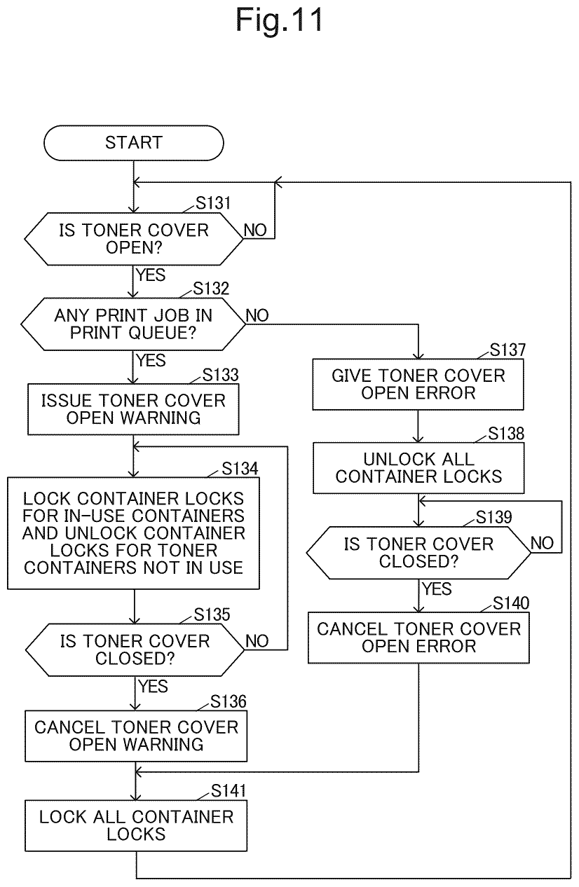

Next, a description will be given of an operation of the image forming apparatus 10 in controlling the container locks. FIG. 11 is a flowchart of the operation of the image forming apparatus 10 in controlling the container locks. When the image forming apparatus 10 is started up, the operation controller 61 executes the operation shown in FIG. 11.

As shown in FIG. 11, the operation controller 61 determines, based on a detection result of the toner cover sensor 42, whether or not the toner cover 41 is open, until it determines that the toner cover 41 is open (S131). In arbitrary cases, such as when a container empty warning is displayed on the display device 12, the user of the image forming apparatus 10 opens the toner cover 41 for arbitrary purposes, such as for replacement of toner containers.

When determining in S131 that the toner cover 41 is open, the operation controller 61 whether or not there is any print job in a print queue 52 at the time of determination in S131 that the toner cover 41 is open (S132).

When determining in S132 that there is any print job in a print queue 52 at the time of determination in S131 that the toner cover 41 is open, the operation controller 61 issues a toner cover open warning (S133). Specifically, the operation controller 61 allows the display device 12 to start displaying a toner cover open warning and writes, into toner cover open warning information 55, that a toner cover open warning is being issued.

When the processing step S133 ends, the operation controller 61 locks the container locks associated with the toner containers shown to be in-use containers in the in-use container information 57, and unlocks the container locks associated with the toner containers not shown to be in-use containers in the in-use container information 57 (S134).

When the processing step S134 ends, the operation controller 61 determines, based on a detection result of the toner cover sensor 42, whether or not the toner cover 41 is closed (S135).

When determining in S135 that the toner cover 41 is not closed, the operation controller 61 executes the processing step S134.

When determining in S135 that the toner cover 41 is closed, the operation controller 61 cancels the toner cover open warning (S136). Specifically, the operation controller 61 allows the display device 12 to terminate displaying the toner cover open warning and writes, into the toner cover open warning information 55, that no toner cover open warning is issued.

When determining in S132 that there is no print job in a print queue 52 at the time of determination in S131 that the toner cover 41 is open, the operation controller 61 gives a toner cover open error (S137). Specifically, the operation controller 61 allows the display device 12 to start displaying a toner cover open error and writes, into toner cover open error information 56, that a toner cover open error is occurring.

When the processing step S137 ends, the operation controller 61 unlocks all the container locks (S138).

When the processing step S138 ends, the operation controller 61 determines, based on a detection result of the toner cover sensor 42, whether or not the toner cover 41 is closed, until it determines that the toner cover 41 is closed (S139).

When determining in S139 that the toner cover 41 is closed, the operation controller 61 cancels the toner cover open error (S140). Specifically, the operation controller 61 allows the display device 12 to terminate displaying the toner cover open error and writes, into the toner cover open error information 56, that no toner cover open error is occurring.

When the processing step S136 or processing step S140 ends, the operation controller 61 locks all the container locks (S141) and executes the processing step S131.

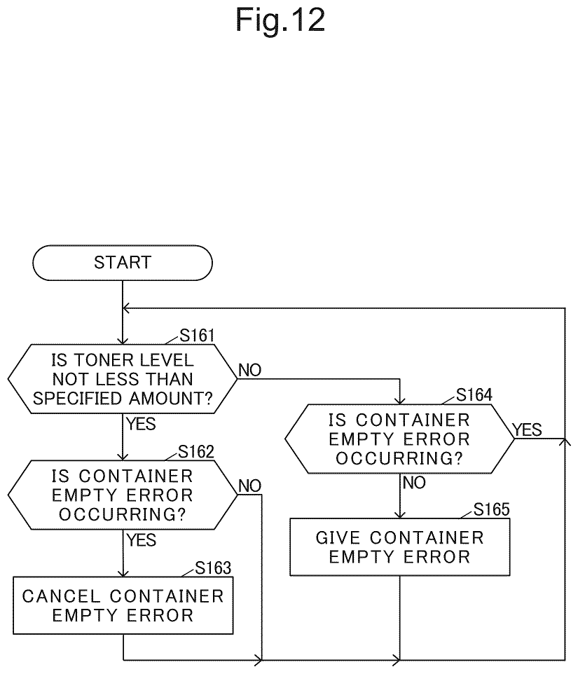

Next, a description will be given of an operation of the image forming apparatus 10 for a container empty error. FIG. 12 is a flowchart of the operation of the image forming apparatus 10 for a container empty error. When the image forming apparatus 10 is started up, the operation controller 61 executes the operation shown in FIG. 12 for each hopper toner level sensor.

As shown in FIG. 12, the operation controller 61 determines, based on a detection result of each hopper toner level sensor, whether or not the toner level in the associated hopper is not less than a specified amount (S161).

When determining in S161 that the toner level in the hopper is not less than the specified amount, the operation controller 61 determines, based on container empty error subject information 54, whether or not a container empty error on the toner color of the hopper associated with the hopper toner level sensor is occurring (S162).

When determining in S162 that a container empty error on the toner color of the hopper associated with the hopper toner level sensor is occurring, the operation controller 61 cancels the container empty error on the toner color of the hopper associated with the hopper toner level sensor (S163). Specifically, the operation controller 61 allows the display device 12 to terminate displaying a container empty error on the toner color of the hopper associated with the hopper toner level sensor and deletes the toner color of the hopper associated with the hopper toner level sensor from the container empty error subject information 54.

When the operation controller 61 determines in S162 that no container empty error on the toner color of the hopper associated with the hopper toner level sensor is occurring or when the processing step S163 ends, the operation controller 61 executes the processing step S161.

When determining in S161 that the toner level in the hopper is less than the specified amount, the operation controller 61 determines whether or not a container empty error on the toner color of the hopper associated with the hopper toner level sensor is occurring (S164).

When determining in S164 that no container empty error on the toner color of the hopper associated with the hopper toner level sensor is occurring, the operation controller 61 gives a container empty error on the toner color of the hopper associated with the hopper toner level sensor (S165). Specifically, the operation controller 61 allows the display device 12 to display a container empty error on the toner color of the hopper associated with the hopper toner level sensor and adds the toner color of the hopper associated with the hopper toner level sensor into the container empty error subject information 54.

When the operation controller 61 determines in S164 that a container empty error on the toner color of the hopper associated with the hopper toner level sensor is occurring or when the processing step S165 ends, the operation controller 61 executes the processing step S161.

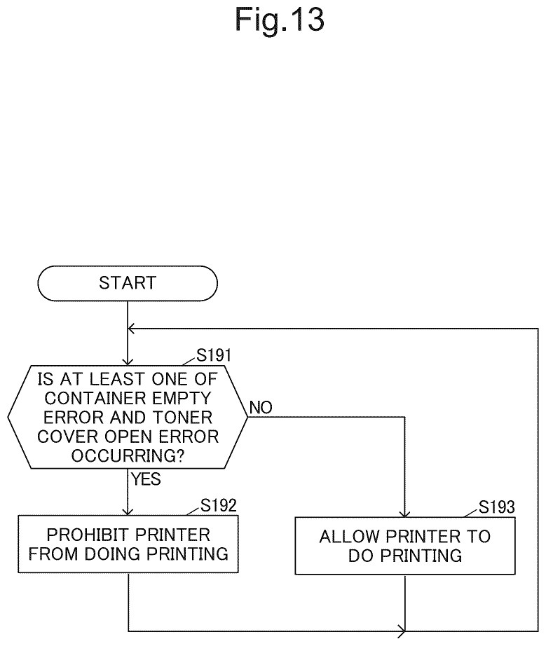

Next, a description will be given of an operation of the image forming apparatus 10 in determining whether to prohibit or allow printing. FIG. 13 is a flowchart of the operation of the image forming apparatus 10 in determining whether to prohibit or allow printing. When the image forming apparatus 10 is started up, the operation controller 61 executes the operation shown in FIG. 13.

As shown in FIG. 13, the operation controller 61 determines, based on the container empty error subject information 54 and the toner cover open error information 56, whether or not at least one of a container empty error and a toner cover open error is occurring (S191).

When determining in S191 that at least one of a container empty error and a toner cover open error is occurring, the operation controller 61 prohibits the printer 20 from doing printing (S192). Specifically, when the printer 20 is in execution of printing, the operation controller 61 stops the printing being executed by the printer 20. When the printer 20 is not in execution of printing, the operation controller 61 prohibits the printer 20 from newly doing printing.

When determining in S191 that neither container empty error nor toner cover open error is occurring, the operation controller 61 allows the printer 20 to do printing (S193). Specifically, when the printer 20 is in execution of printing, the operation controller 61 allows the printer 20 to continue the printing in execution. When the printer 20 is not in execution of printing, the operation controller 61 allows the printer 20 to newly do printing.

After executing the processing step S192 or processing step S193, the operation controller 61 executes the processing step S191.

As described previously, since during execution of printing the image forming apparatus 10 allows restriction on the removal of each of in-use containers to be imposed by its associated combination of a container cover and a container lock and lifts restriction on the removal of each of the toner containers other than the in-use containers imposed by its associated combination of a container cover and a container lock (S134), the likelihood of toner scattering when toner containers are replaced during execution of printing can be reduced.

In the absence of any print job in a print queue 52 at the time of determination that the toner cover 41 is open based on a detection result of the toner cover sensor 42 (NO in S132), the image forming apparatus 10 restricts the execution of printing with the toner cover 41 open (S137 to S140, YES in S191 and S192). In the presence of any print job in a print queue 52 at the time of determination that the toner cover 41 is open based on the detection result of the toner cover sensor 42 (YES in S132), the image forming apparatus 10 executes printing based on the print job present in the print queue 52 although the toner cover 41 is open (NO in S191 and S193). Therefore, when toner containers are replaced during execution of printing, there is no need to restrict the execution of printing, which increases convenience.

In the image forming apparatus 10 according to this embodiment, two toner containers can be fitted for the same color. However, the image forming apparatus 10 may be designed so that three or more toner containers can be fitted for the same color.

In this embodiment, the container lock locks the associated container cover, thus restricting removal of the associated toner container. However, the removal restricting device may be other than a combination of a container cover and a container lock so long as it can restrict the removal of the toner container.

For example, in a general image forming apparatus not according to this embodiment, there arises a problem that toner scatters when toner containers are replaced during execution of printing. Unlike this, in the above embodiment, the likelihood of toner scattering when toner containers are replaced during execution of printing can be reduced.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
an image forming device that comprises a plurality of toner containers for each same color fitted therein and does printing, the image forming device further comprising, for the plurality of toner containers, respective removal restricting devices that restrict removal of the respective associated toner containers; and
a control device that comprises a processor and functions as an operation controller through the processor executing a control program,
wherein the operation controller manages an in-use container which is, among the plurality of toner containers, the toner container used for execution of the printing, allows the removal restricting device for the in-use container to restrict the removal of the in-use container during the execution of printing, and lifts, during the execution of printing, restriction imposed by the other removal restricting devices on the removal of the toner containers other than the in-use container.

2. The image forming apparatus according to claim 1, further comprising:
a toner cover that is opened in removing each of the toner containers; and
a toner cover sensor that detects whether the toner cover is open or closed,
wherein in absence of any print job in a print queue at the time of determination that the toner cover is open based on a detection result of the toner cover sensor, the operation controller restricts execution of printing by the image forming device while the toner cover is open, and
in presence of any print job in the print queue at the time of determination that the toner cover is open based on the detection result of the toner cover sensor, the operation controller allows the image forming device to do printing based on the print job even when the toner cover is open.

3. The image forming apparatus according to claim 2,
further comprising a notification device that gives notice to a user,
wherein in presence of any print job in the print queue at the time of determination that the toner cover is open based on the detection result of the toner cover sensor and when the operation controller allows the image forming device to do printing based on the print job even when the toner cover is open, the operation controller allows the notification device to issue a warning that the toner cover is open.

4. A non-transitory computer-readable recording medium with an operation control program stored therein, the operation control program allowing a computer included in an image forming apparatus, the image forming apparatus comprising: a plurality of toner containers for each same color fitted therein; and, for the plurality of toner containers, respective removal restricting devices that restrict removal of the respective associated toner containers, to operate to manage an in-use container which is, among the plurality of toner containers, the toner container used for execution of printing, allow the removal restricting device for the in-use container to restrict the removal of the in-use container during the execution of printing, and lift, during the execution of printing, restriction imposed by the other removal restricting devices on the removal of the toner containers other than the in-use container.
